(19) United States
(12) Patent Application Publication
(10) Pub. No.: US 2010/0209772 A1
(43) Pub. Date: Aug. 19, 2010

(54) NON-AQUEOUS ELECTROLYTE, AND RECHARGEABLE LITHIUM BATTERY INCLUDING THE SAME

(75) Inventors: Doo-Kyoung Lee, Suwon-si (KR); Sung-Soo Kim, Suwon-si (KR); Kyoung-Han Yew, Suwon-si (KR); Nam-Soon Choi, Suwon-si (KR); Su-Yeong Park, Suwon-si (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., LTD., Suwon-si (KR)

(21) Appl. No.: 12/706,564

(22) Filed: Feb. 16, 2010

(30) Foreign Application Priority Data
Feb. 16, 2009 (KR) 10-2009-0012450

(51) Int. Cl. H01M 10/26

(52) U.S. Cl. 429/207

(57) ABSTRACT

Disclosed is a non-aqueous electrolyte and a lithium rechargeable battery including the same, a first lithium salt represented by the following Chemical Formula 1, and a second lithium salt excluding boron.

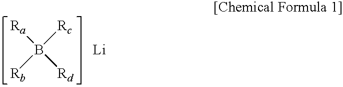

In the above Chemical Formula 1, Rₐ to R_{d} are substituted or unsubstituted alkyl, substituted or unsubstituted alkylene, substituted or unsubstituted alkylene oxide, or a halogen, or one or more non-adjacent —CH₂— in the alkyl, alkylene, and alkyleneoxide is/are replaced with —CO—. At least two of Rₐ to R_{d} may be fused to form a ring. The non-aqueous electrolyte according to one embodiment of the present invention improves the cycle-life characteristic of high capacity battery by forming a stable passivation film in the interface between the negative electrode and the non-aqueous electrolyte and increasing the concentration of lithium ion in electrolyte.

### CLAIM OF PRIORITY

This application makes reference to, incorporates the same herein, and claims all benefits accruing under 35 U.S.C. §119 from an application for NON-AQUEOUS ELECTROLYTE, AND RECHARGEABLE LITHIUM BATTERY INCLUDING THE SAME earlier filed in the Korean Intellectual Property Office on 16 Feb. 2009 and there duly assigned Serial No. 10-2009-0012450.

### BACKGROUND OF THE INVENTION

1. Field of the Invention

The present invention relates to a non-aqueous electrolyte, and, more particularly to a lithium rechargeable battery including a non-aqueous electrolyte.

2. Description of the Related Art

A lithium rechargeable battery has recently drawn attention as a power source for small portable electronic devices. It uses an organic electrolyte solution and has twice as high a discharge voltage as a conventional battery using an alkali aqueous solution, and accordingly has a high energy density.

For positive electrode active materials of a rechargeable lithium battery, lithium-transition element composite oxides capable of intercalating lithium such as LiCoO₂, LiMn₂O₄, LiNiO₂, LiNi₁₋ₓCOₓO₂ (0<x<1), and so on, have been studied.

As for negative electrode active materials of a rechargeable lithium battery, various carbon-based materials such as artificial graphite, natural graphite, and hard carbon have been used, which can all intercalate and deintercalate lithium ions. Graphite, of the carbon-based materials, increases discharge voltages and energy density for a battery because it has a low discharge potential of −0.2V compared to lithium. A battery using graphite as a negative active material has a high average discharge potential of 3.6V and excellent energy density. Furthermore, graphite is most often used among the aforementioned carbon-based materials since graphite guarantees better cycle life for a battery due to its outstanding reversibility.

Graphite active material however has low density and consequently a low capacity in terms of energy density per unit volume when used as a negative active material. Further, graphite involves danger such as explosion or combustion when a battery is misused or overcharged and the like, because graphite is likely to react with an organic electrolyte at high discharge voltages.

In order to solve these problems, a great deal of research on oxide negative electrodes has recently been performed. Oxide negative electrodes however do not show sufficiently suitable performance in a battery, and therefore, there has been a great deal of further research into oxide negative materials to address this problem.

Negative active materials have a problem because they may cause an abrupt decrease in the cycle life of a battery due to an electrochemical reaction between the negative active material and electrolyte during charge and discharge.

### SUMMARY OF THE INVENTION

An exemplary embodiment of the present invention provides a non-aqueous electrolyte for improving cycle life of a high-capacity battery.

Another embodiment of the present invention provides a lithium rechargeable battery including the non-aqueous electrolyte.

According to an embodiment of the present invention, a non-aqueous electrolyte is provided that includes non-aqueous solvent, a first lithium salt represented by the following Chemical Formula 1, and a second lithium salt excluding boron.

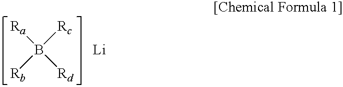

In the Chemical Formula 1,

Rₐ to R_{d} are the same or different, and are independently of each other substituted or unsubstituted alkyl, substituted or unsubstituted alkylene, substituted or unsubstituted alkylene oxide, or halogen, or one or more non-adjacent —CH₂— in the alkyl, alkylene, and alkylene oxide is/are replaced with —CO—. At least two of the Rₐ to R_{d} may be fused to form a ring.

The first lithium salt may be LiFOB, LiB(C₂O₄)₂, or combinations thereof.

The second lithium salt may be selected from the group consisting of LiPF₆, LiSbF₆, LiAsF₆, LiClO₄, LiCF₃SO₃, LiC₄F₉SO₃, LiN(CF₃SO₂)₂, LiN(C₂F₅SO₂)₂, LiAlO₄, LiAlCl₄, LiN(CₚF₂ₚ₊₁SO₂)(C_{q}F_{2q+1}SO₂) where p and q are natural numbers, LiSO₃CF₃, LiCl, LiI, and combinations thereof.

The first lithium salt and the second lithium salt may be included at a mole ratio of about 0.01:1.7 to about 1.0:0.5. In one embodiment, the first lithium salt and the second lithium salt may be included at a mole ratio of about 0.1 to 1:1, and in another embodiment, the first lithium salt and the second lithium salt may be included at a mole ratio of about 0.4 to 1:1.

According to another embodiment of the present invention, a lithium rechargeable battery is provided that includes a negative electrode including a negative active material selected from the group consisting of a material capable of alloying with lithium, a transition metal oxide, a material capable of doping and dedoping lithium, and combinations thereof; non-aqueous electrolyte including non-aqueous solvent, a first lithium salt represented by the above Chemical Formula 1, a second lithium salt excluding boron; and a positive electrode.

The material capable of alloying with lithium includes one selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, Bi, and combinations thereof.

Examples of the transition metal oxide, and material capable of doping and dedoping lithium include one selected from the group consisting of vanadium oxide, lithium vanadium oxide, Si, SiOₓ (0<x<2), Sn, SnO₂, tin alloy composites, silicon alloy composites, and combinations thereof.

The non-aqueous electrolyte according to one embodiment improves the cycle-life characteristic of a high capacity battery by forming a stable passivation film in the interface between the negative electrode and the non-aqueous electrolyte and increasing the concentration of lithium ion in the non-aqueous electrolyte.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is an exploded isometric view showing a lithium rechargeable battery according to an exemplary embodiment of the present invention.

### DETAILED DESCRIPTION OF THE INVENTION

Exemplary embodiments of the present invention will hereinafter be described in detail. These embodiments are only exemplary, however, and the present invention is not limited thereto.

As used herein, when a specific definition is not provided, the terms “substituted alkyl, substituted alkylene, substituted alkylene oxide respectively refer to alkyl, alkylene, and alkylene oxide substituted with one substance selected from the group consisting of halogen, substituted or unsubstituted alkyl, substituted or unsubstituted alkenyl, substituted or unsubstituted aryl, substituted or unsubstituted cycloalkyl, substituted or unsubstituted heteroaryl, substituted or unsubstituted heteroalkyl, and substituted or unsubstituted heterocycloalkyl.

As used herein, when a specific definition is not provided, the term “an alkyl” refers to in one embodiment C1 to C30 alkyl, or in another embodiment a C1 to C8 alkyl. The term “an alkylene” refers to in one embodiment a C1 to C30 alkylene, or in another embodiment a C1 to C8 alkylene, the term “an alkylene oxide” refers to in one embodiment a C1 to C30 alkylene oxide, or in another embodiment a C1 to C8 alkylene oxide, the term “an aryl” refers to in one embodiment a C6 to C30 aryl, or in another embodiment a C6 to C13 aryl, the term “a cycloalkyl” refer to in one embodiment a C3 to C30 cycloalkyl, or in another embodiment a C3 to C8 cycloalkyl, the term “a heteroaryl” refers to in one embodiment a C1 to C30 heteroaryl, or in another embodiment a C1 to C10 heteroaryl, the term “heteroalkyl” refers to in one embodiment a C1 to C30 heteroalkyl, or in another embodiment a C1 to C8 heteroalkyl, and the term “a heterocycloalkyl” refers to in one embodiment a C1 to C30 heterocycloalkyl, or in another embodiment a C1 to C8 heterocycloalkyl.

One exemplary embodiment of the present invention provides a non-aqueous electrolyte that includes a non-aqueous solvent, a first lithium salt represented by the following Chemical Formula 1, and a second lithium salt excluding boron.

The lithium salt represented by Chemical Formula 1 suppresses irreversible reaction and improves the cycle-life characteristic by forming a stable passivation film having excellent ion-conductivity on the surface of a negative electrode after charge and discharge.

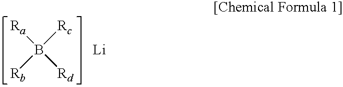

In the Chemical Formula 1,

Rₐ to R_{d} are the same or different, and are independently of each other substituted or unsubstituted alkyl, substituted or unsubstituted alkylene, substituted or unsubstituted alkylene oxide, or halogen, or one or more non-adjacent —CH₂— in the alkyl, alkylene, and alkyleneoxide is/are replaced with —CO—. At least two of Rₐ to R_{d} may be optionally fused to form a ring.

In one embodiment, in the first lithium salt represented by the above Chemical Formula 1, it is preferable that Rₐ to R_{d} are alkylene oxide, and one or more non-adjacent —CH₂— in the alkylene oxide is/are replaced with —CO—, and at least two of Rₐ to R_{d} are fused to form a ring.

Non-limiting examples of the first lithium salt include LiFOB (i.e., lithium difluoro(oxalato) borate), LiB (i.e., lithium bis(oxalato) borate) (C₂O₄)₂ (hereinafter, referred to as “LiBOB”), or combinations thereof.

Non-limiting examples of the second lithium salt include LiPF₆, LiSbF₆, LiAsF₆, LiClO₄, LiCF₃SO₃, LiC₄F₉SO₃, LiN(CF₃SO₂)₂, LiN(C₂F₅SO₂)₂, LiAlO₄, LiAlCl₄, LiN(CₚF₂ₚ₊₁SO₂)(C_{q}F_{2q+1}SO₂) where p and q are natural numbers, LiSO₃CF₃, LiCl, or LiI, or combinations thereof.

The first lithium salt and the second lithium salt may be included in a mole ratio of about 0.01:1.7 to about 1.0:0.5. Broadly, the mole ratio of the first lithium salt to the second lithium salt is within a range of about 0.01:1.7. Furthermore, according to one embodiment, the mole ratio of the first lithium salt and the second lithium salt is about 0.01:0.5, about 0.05:0.5, about 0.1:0.5, about 0.5:0.5, about 1.0:0.5, about 0.01:1.0, about 0.05:1.0, about 0.1:1.0, about 0.5:1.0, about 1.0:1.0, about 0.01:1.7, about 0.05:1.7, about 0.1:1.7, about 0.5:1.7, or about 1.0:1.7. When the mixing ratio of the first lithium salt is less than about 0.01:1.7, it may insufficiently acts as a heterogeneous salt; on the other hand, when it is too high, the overall ion conductivity may be decreased and deteriorate cell performance. In addition, when the first lithium salt is LiBOB and is added in more than the mixing ratio of about 1.0:0.5, it may cause the problem of deposition due to its' low solubility.

According to one embodiment, the total concentration of lithium salt including the first lithium salt and the second lithium salt ranges from about 0.1 to 2.0M. When the concentration of the lithium salt is less than 0.1M, the conductivity of electrolyte is decreased to deteriorate the electrolyte's performance; on the other hand, when the concentration of the lithium salt is more than 2.0M, the viscosity of electrolyte is increased to decrease the mobility of the lithium ions.

When the first lithium salt and the second lithium salt are mixed, the durability is improved since the passivation film component formed on the surface of the negative active material is further improved, so the passivation film decreases direct contact between the negative electrode and the electrolyte. Accordingly, the battery's cycle-life characteristic is further improved.

According to another embodiment of the present invention, a lithium rechargeable battery is provided. The lithium rechargeable battery includes a negative electrode including a negative active material selected from the group consisting of a material capable of alloying with lithium, transition metal oxide, a material capable of doping and dedoping lithium, and combinations thereof; non-aqueous electrolyte including non-aqueous solvent, a first lithium salt represented by the following Chemical Formula 1, a second lithium salt excluding boron; and a positive electrode.

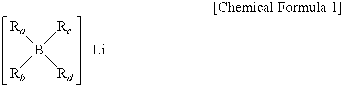

In the Chemical Formula 1,

Rₐ to R_{d} are the same or are different, and are independently of each other substituted or unsubstituted alkyl, substituted or unsubstituted alkylene, substituted or unsubstituted alkylene oxide, or halogen, or one or more non-adjacent —CH₂— in the alkyl, alkylene, and alkyleneoxide is/are replaced with —CO—. At least two of Rₐ to R_{d} may be optionally fused to form a ring.

Rechargeable lithium batteries may be classified as lithium ion batteries, lithium ion polymer batteries, and lithium polymer batteries according to the presence of a separator and the kind of electrolyte used in the battery. The rechargeable lithium batteries may have a variety of shapes and sizes, and include cylindrical, prismatic, or coin-type batteries, and may be thin film batteries or may be rather bulky in size. Structures and fabricating methods for lithium ion batteries pertaining to the present invention are well known in the art.

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention.

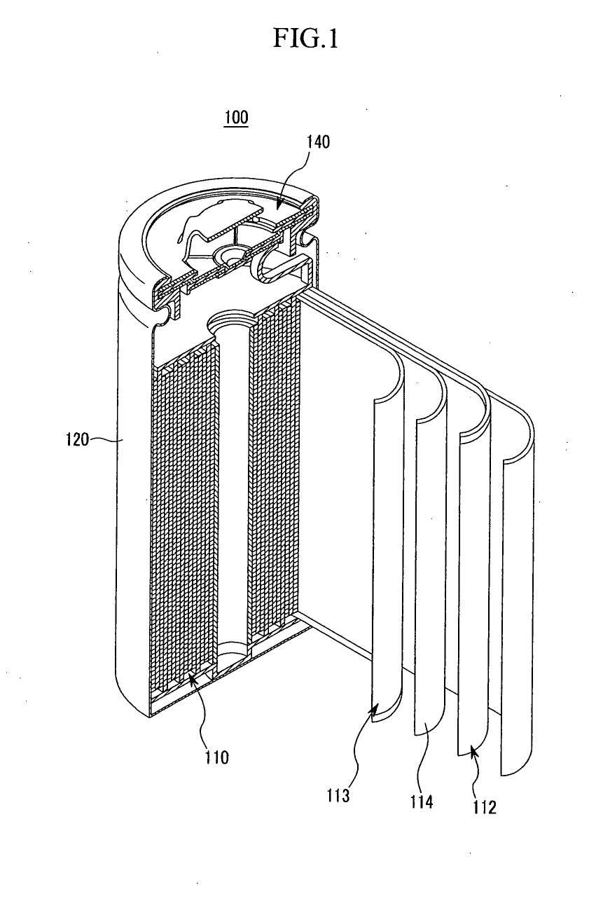

FIG. 1 is an exploded isometric view showing a lithium rechargeable battery according to an exemplary embodiment of the present invention. FIG. 1 shows a cylindrical battery of a rechargeable lithium battery according to one embodiment of the present invention, but the rechargeable lithium battery according to the present invention is not limited thereto, and may have any shape such as prismatic, pouch, and in particular implementations of the principles of the present invention, may have shapes representing other geometric constructs.

Referring to FIG. 1, the rechargeable lithium battery 100 includes an electrode assembly 110 in which a positive electrode 112 and a negative electrode 113 are disposed with a separator 114 interposed therebetween, and a case 120 formed with an opening on the end of one side in order to insert the electrode assembly 110 together with an electrolyte solution. A cap assembly 140 is mounted on the opening of the case 120 to seal battery 100.

The negative electrode 113 includes a current collector and a negative active material layer disposed on the current collector, and the negative active material layer includes a negative active material.

The negative active material may be selected from the group consisting of a material capable of alloying with lithium, transition metal oxide, a material capable of doping and dedoping lithium, a material capable of forming a lithium-included compound by reversible reaction with lithium, and combinations thereof.

The material capable of alloying with lithium includes one material selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, Bi, and combinations thereof. Examples of the transition metal oxide, material capable of doping and dedoping lithium, material capable of forming a lithium-included compound by reversible reaction with lithium include one selected from the group consisting of vanadium oxide, lithium vanadium oxide, Si, SiOₓ (0<x<2), Sn, SnO₂, tin alloy composites, silicon alloy composites, and combinations thereof.

The cycle life of such a negative active material may be liable to decrease due to electrochemical reaction between the negative active material and electrolyte during charge and discharge. The problem may be solved however by including the non-aqueous electrolyte including a lithium salt represented by Chemical Formula 1.

When a lithium ion is applied to the negative active material, the lithium ion is captured in the negative active material or wasted by the reaction, because the reaction is irreversible, in the initial formation discharge. The lithium ion in the electrolyte is intercalated into the positive electrode in order to compensate for the wasted amount of lithium ion, so the quantity of lithium ions in the electrolyte are significantly decreased which consequently deteriorates the cycle-life of the battery.

When the non-aqueous electrolyte includes the first lithium salt represented by Chemical Formula 1 however, the concentration of lithium ions can be maintained at a certain level so as to improve the cycle-life deterioration even when the concentration of lithium ions in the electrolyte is increased so as to intercalate the lithium ion into the positive electrode.

The negative active material layer includes a binder, and optionally a conductive material.

The binder improves binding properties of the negative active material particles to each other and to a current collector. Examples of the binder include polyvinyl alcohol, carboxylmethyl cellulose, hydroxypropyl cellulose, polyvinyl chloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless that material causes a chemical change. Examples of the conductive material include natural graphite, artificial graphite, carbon black, acetylene black, ketjen black, a carbon fiber, a metal powder or a metal fiber including copper, nickel, aluminum, silver, and so on, and a polyphenylene derivative.

The current collector may be selected from the group consisting of a copper foil, a nickel foil, a stainless steel foil, a titanium foil, a nickel foam, a copper foam, a polymer substrate coated with a conductive metal, and combinations thereof.

Positive electrode 112 includes a current collector and a positive active material layer disposed on the current collector.

The positive active material includes lithiated intercalation compounds that reversibly intercalate and deintercalate lithium ions. Non-limiting examples of the positive active material include the compounds represented by the following Chemical Formulae: LiₐA_{1-b}Z_{b}D₂ (wherein, 0.90≦a≦1.8, and 0≦b≦0.5); LiₐE_{1-b}Z_{b}O_{2-c}D_{c} (wherein, 0.90≦a≦1.8, 0≦b≦0.5, and 0≦c≦0.05); LiE_{2-b}Z_{b}O_{4-c}D_{c} (wherein, 0≦b≦0.5, and 0≦c≦0.05); LiₐNi_{1-b-c}Co_{b}Z_{c}D_{α} (wherein, 0.90≦a≦1.8, 0≦b≦0.5, 0≦c≦0.05, 0≦c≦0.05, and 0<α<2); LiₐNi_{1-b-c}Co_{b}Z_{c}O_{2-α}L₂ (wherein, 0.90≦a≦1.8, 0≦b≦0.5, 0≦c≦0.05, and 0<α<2); LiₐNi_{1-b-c}Mn_{b}Z_{c}D_{α} (wherein, 0.90≦a≦1.8, 0≦b≦0.5, 0≦c≦0.05, and 0<α2); LiₐNi_{1-b-c}Mn_{b}Z_{c}O_{2-α}L_{α} (wherein, 0.90≦a≦1.8, 0≦b≦0.5, 0≦c≦0.05, and 0<α<2); LiₐNi_{1-b-c}Mn_{b}Z_{c}O_{2-α}L₂ (wherein, 0.90≦a≦1.8, 0≦b≦0.5, 0≦c≦0.05, and 0<α<2); LiₐNi_{b}E_{c}G_{d}O₂ (wherein, 0.90≦a≦1.8, 0≦b≦0.9, 0≦c≦0.5, and 0.001≦d≦0.1); LiₐNi_{b}Co_{c}Mn_{d}GₑO₂ (wherein, 0.90≦a≦1.8, 0≦b≦0.9, 0≦c≦0.5, 0≦d≦0.5, and 0.001≦e≦0.1); LiₐNiG_{b}O₂ (wherein, 0.90≦a≦1.8, and 0.001≦b≦0.1); LiₐCoG_{b}O₂ (wherein, 0.90≦a≦1.8, and 0.001≦b≦0.1); LiₐMnG_{b}O₂ (wherein, 0.90≦a≦1.8, and 0.001≦b≦0.1); LiₐMn₂G_{b}O₄ (wherein, 0.90≦a≦1.8, and 0.001≦b≦0.1); QO₂; QS₂; LiQS₂; V₂O₅; LiV₂O₅; LiMO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above chemical formulae, A is selected from the group consisting of Ni, Co, Mn, and combinations thereof; Z is selected from the group consisting of Al, Ni, Co, Mn, Cr, Fe, Mg, Sr, V, a rare earth element, and combinations thereof; D is selected from the group consisting of O, F, S, P, and combinations thereof; E is selected from the group consisting of Co, Mn, and combinations thereof; L is selected from the group consisting of F, S, P, and combinations thereof; G is selected from the group consisting of Al, Cr, Mn, Fe, Mg, La, Ce, Sr, V, and combinations thereof; Q is selected from the group consisting of Ti, Mo, Mn, and combinations thereof; M is selected from the group consisting of Cr, V, Fe, Sc, Y, and combinations thereof; and J is selected from the group consisting of V, Cr, Mn, Co, Ni, Cu, and combinations thereof.

The compound used for the positive active material may have a coating layer on the surface, or may be mixed with a compound having a coating layer.

The coating layer may include at least one coating element compound selected from the group consisting of an oxide of a coating element, a hydroxide, an oxyhydroxide of a coating element, an oxycarbonate of a coating element, and a hydroxyl carbonate of a coating element. The compounds for a coating layer can be amorphous or crystalline. The coating element for a coating layer may include Mg, Al, Co, K, Na, Ca, Si, Ti, V, Sn, Ge, Ga, B, As, Zr, or mixtures thereof.

The coating layer may be formed by any method having no negative influence on the properties of a positive active material by including these elements in the compound. For example, the method may include any coating method such as spray coating, dipping, and the like, but is not illustrated in more detail, since it is well-known to those of ordinary skill in the art.

The positive active material layer also includes a binder and a conductive material.

The binder improves binding properties of the positive active material particles to each other and to a current collector. Examples of the binder include polyvinyl alcohol, carboxylmethyl cellulose, hydroxypropyl cellulose, diacetyl cellulose, polyvinylchloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

Any electrically conductive material may be used as a conductive material unless the material causes a chemical change. Examples of the conductive material include natural graphite, artificial graphite, carbon black, acetylene black, ketjen black, a carbon fiber, a metal powder or a metal fiber including copper, nickel, aluminum, silver, and so on, and a polyphenylene derivative.

The current collector may be Al, but is not limited thereto.

The negative electrode 113 and positive electrode 112 may be fabricated by a method including mixing the active material, a conductive material, and a binder to provide an active material composition, and coating the composition on a current collector. The electrode manufacturing method is well known, and thus is not described in detail in the present specification. The solvent may be N-methylpyrrolidone, but it is not limited thereto.

The non-aqueous electrolyte includes a non-aqueous solvent and a lithium salt.

The non-aqueous organic solvent acts as a medium for transmitting ions taking part in the electrochemical reaction of the battery.

The non-aqueous organic solvent may include a carbonate-based, ester-based, ether-based, ketone-based, alcohol-based, or aprotic solvent. The carbonate-based solvent includes dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent includes methyl acetate, ethyl acetate, n-propyl acetate, dimethyl acetate, methyl propionate, ethyl propionate, γ-butyrolactone, decanolide, valerolactone, mevalonolactone, caprolactone, and the like.

The ether-based solvent includes dibutyl ether, tetraglyme, diglyme, dimethoxyethane, 2-methyltetrahydrofuran, tetrahydrofuran, and the like. The ketone-based solvent includes cyclohexanone. Examples of the alcohol-based solvent include ethyl alcohol, isopropyl alcohol, and so on, and examples of the aprotic solvent include nitriles such as R—CN (wherein R is a C2 to C20 linear, branched, or cyclic hydrocarbon, a double bond, an aromatic ring, or an ether bond), amides such as dimethylformamide, dioxolanes such as 1,3-dioxolane, sulfolanes, and so on.

The non-aqueous organic solvent may be used singularly or in a mixture. When the organic solvent is used in a mixture, the mixture ratio may be controlled in accordance with a desirable battery performance.

According to one embodiment of the present invention, the cyclic carbonate and the chain carbonate are preferably mixed together. When the cyclic carbonate and the chain carbonate are mixed in the volume ratio of about 1:1 to 1:9 and the mixture is used as an electrolyte, the electrolyte performance may be enhanced.

The non-aqueous organic solvent may include a mixture of carbonate-based solvents and an aromatic hydrocarbon-based solvent. The carbonate-based solvent and the aromatic hydrocarbon-based solvent are preferably mixed together in a volume ratio of about 1:1 to 30:1.

The aromatic hydrocarbon-based organic solvent may be represented by the following Chemical Formula 2.

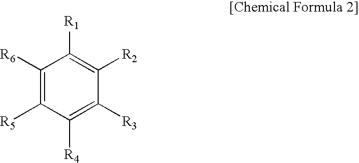

In the above Chemical Formula 2, R₁ to R₆ are independently selected from the group consisting of hydrogen, halogen, C1 to C10 alkyl, C1 to 010 haloalkyl, and combinations thereof.

The aromatic hydrocarbon-based organic solvent includes one selected from the group consisting of benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, and combinations thereof.

The non-aqueous electrolyte may further include a vinylene carbonate or an ethylene carbonate-based compound of the following Chemical Formula 3.

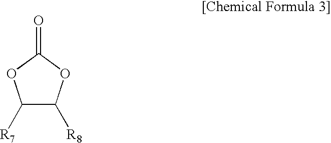

In the above Chemical Formula 3, R₇ and R₈ are independently hydrogen, halogen, cyano (CN), nitro (NO₂), and C1 to C5 fluoroalkyl, provided that at least one of R₇ and R₈ is a halogen, a nitro (NO₂), or a C1 to C5 fluoroalkyl and R₇ and R₈ are not simultaneously hydrogen.

The ethylene carbonate-based compound includes difluoroethylene carbonate, chloroethylene carbonate, dichloroethylene carbonate, bromoethylene carbonate, dibromoethylene carbonate, nitroethylene carbonate, cyanoethylene carbonate, or fluoroethylene carbonate. The amount of the additive for improving cycle life may be adjusted within an appropriate range. In one embodiment however, it may be included in an amount of about 1 to 10 parts by weight based on 100 parts by weight of the non-aqueous organic solvent.

The lithium salt supplies lithium ions in the battery, and performs a basic operation of a rechargeable lithium battery by improving lithium ion transport between positive and negative electrodes. The lithium salt is the same as described above.

The rechargeable lithium battery may further include a separator between a negative electrode and a positive electrode, as needed. Non-limiting examples of suitable separator materials include polyethylene, polypropylene, polyvinylidene fluoride, and multi-layers thereof such as a polyethylene/polypropylene double-layered separator, a polyethylene/polypropylene/polyethylene triple-layered separator, and a polypropylene/polyethylene/polypropylene triple-layered separator.

The following examples illustrate the present invention in more detail. These examples, however, should not in any sense be interpreted as limiting the scope of the present invention.

### Manufacturing Lithium Rechargeable Battery

### Example 1

A negative active material of SiOₓ (X=1), polyvinylidene fluoride, and a conductive material of Super P were mixed in a ratio of 90:8:2 in N-methylpyrrolidone to provide a negative electrode slurry.

The negative electrode slurry was coated on a copper foil (Cu-foil) in a thickness of 80 μm to provide a thin electrode plate, dried at 135° C. for 3 hours, and pressed to provide a negative electrode plate having a thickness of 45 μm.

The obtained negative electrode was used for a working electrode, a metal lithium foil was used for a counter electrode, and a separator composed of a porous polypropylene film was interposed between the working electrode and the counter electrode. LiPF₆ and LiBOB of a mole ratio of 7:3 were dissolved into a mixed solvent (PC:DEC:EC=1:1:1) of propylene carbonate (PC), diethyl carbonate (DEC), and ethylene carbonate (EC) into a concentration of 1M to provide a electrolyte solution. With them, a 2016 coin type half cell was provided.

### Example 2

A half cell was fabricated in accordance with the same procedure as in Example 1, except that LiFOB was used instead of LiBOB.

### Example 3

A half cell was fabricated in accordance with the same procedure as in Example 1, except that LiPF₆ and LiBOB were added in a mole ratio of 6:4.

### Example 4

A half cell was fabricated in accordance with the same procedure as in Example 1, except that LiPF₆ and LiBOB were added in a mole ratio of 5:5.

### Example 5

A half cell was fabricated in accordance with the same procedure as in Example 1, except that LiPF₆ and LiBOB were added in a mole ratio of 8:2.

### Example 6

A half cell was fabricated in accordance with the same procedure as in Example 1, except that LiPF₆ and LiBOB were added in a mole ratio of 9:1.

### Example 7

A half cell was fabricated in accordance with the same procedure as in Example 1, except that LiPF₆ and LiBOB were added in a mole ratio of 4:6.

### Example 8

A half cell was fabricated in accordance with the same procedure as in Example 1, except that LiPF₆ and LiBOB were added in a mole ratio of 3:7.

### Comparative Example 1

A half cell was fabricated in accordance with the same procedure as in Example 1, except that LiBOB was not used.

### Measuring Battery Performance

Each half cell obtained from Examples 1 to 6 and from Comparative Example 1 was subjected to a constant current charge at 0.5 C until a 50 mV charge is attained, and to a constant current discharge at 0.5 C until 1 V, and the charge and discharge were repeated for 50 cycles in order to determine the cycle-life characteristic. The results are shown in the following Table 1. The cycle-life characteristic indicates capacity retention after 50th charge and discharge with respect to the initial capacity.

TABLE 1

| | | | Mixing ratio | | |
|---|---|---|---|---|---|
| | First | Second | First | Second | Capacity |
| | lithium | lithium | lithium | lithium | retention |
| | salt | salt | salt | salt | (%) |
| Example 1 | LiBOB | LiPF₆ | 3 | 7 | 90 |
| Example 2 | LiFOB | LiPF₆ | 3 | 7 | 72 |
| Example 3 | LiBOB | LiPF₆ | 4 | 6 | 85 |
| Example 4 | LiBOB | LiPF₆ | 5 | 5 | 82 |
| Example 5 | LiBOB | LiPF₆ | 2 | 8 | 79 |
| Example 6 | LiBOB | LiPF₆ | 1 | 9 | 80 |
| Example 7 | LiBOB | LiPF₆ | 6 | 4 | 67 |
| Example 8 | LiBOB | LiPF₆ | 7 | 3 | 60 |
| Comparative | LiBOB | LiPF₆ | 0 | 10 | 52 |
| Example 1 | | | | | |

As shown in Table 1, in the cases of Examples 1 to 6 in which the first lithium salt and the second lithium salt were mixed, they showed remarkably higher capacity retention after the 50th charge and discharge cycle than the capacity retention of Comparative Example 1 in which only LiPF₆ was used.

The present invention is not limited to the embodiments illustrated with the drawings, but can be fabricated with various modifications and equivalent arrangements included within the spirit and scope of the appended claims by a person who is ordinarily skilled in this field. Therefore, the aforementioned embodiments should be understood to be exemplary but not limiting the present invention in any way.

What is claimed is:

1. A non-aqueous electrolyte for a lithium rechargeable battery, comprising:
a non-aqueous solvent;
a first lithium salt represented by the following Chemical Formula 1; and
a second lithium salt excluding boron, 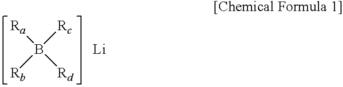
in the Chemical Formula 1,
Rₐ to R_{d} are the same or different, and are independently of each other substituted or unsubstituted alkyl, substituted or unsubstituted alkylene, substituted or unsubstituted alkylene oxide, or halogen, or one or more non-adjacent —CH₂— in the alkyl, alkylene, and alkyleneoxide is/are replaced with —CO—; or at least two of Rₐ to R_{d} are optionally fused to form a ring.

2. The non-aqueous electrolyte of claim 1, wherein Rₐ to R_{d} are alkylene oxide, one or more non-adjacent —CH₂— in the alkylene oxide is/are replaced with —CO—, and at least two of Rₐ to R_{d} are fused to form a ring.

3. The non-aqueous electrolyte of claim 1, wherein the first lithium salt comprises LiFOB, or LiB(C₂O₄)₂, or combinations thereof.

4. The non-aqueous electrolyte of claim 1, wherein: the second lithium salt excluding boron comprises LiPF₆, LiSbF₆, LiAsF₆, LiClO₄, LiCF₃SO₃, LiC₄F₉SO₃, LiN(CF₃SO₂)₂, LiN(C₂F₅SO₂)₂, LiAlO₄, LiAlCl₄, LiN(CₚF₂ₚ₊₁SO₂)(C_{q}F_{2q+1}SO₂) where p and q are natural numbers, LiSO₃CF₃, LiCl, or LiI, or combinations thereof.

5. The non-aqueous electrolyte of claim 1, wherein the first lithium salt and the second lithium salt are included in a mole ratio of about 0.01:1.7 to about 1.0:0.5.

6. The non-aqueous electrolyte of claim 1, wherein the first lithium salt and the second lithium salt are included in a mole ratio of about 0.1 to 1:1.

7. The non-aqueous electrolyte of claim 1, wherein the first lithium salt and the second lithium salt are included in a mole ratio of about 0.4 to 1:1.

8. A lithium rechargeable battery comprising:
a negative electrode including a negative active material selected from the group consisting of a material capable of alloying with lithium, transition metal oxide, a material capable of doping and dedoping lithium, and combinations thereof;
non-aqueous electrolyte including non-aqueous solvent, a first lithium salt represented by the following Chemical Formula 1, and a second lithium salt excluding boron; and
a positive electrode: 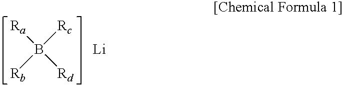
in the Chemical Formula 1,
Rₐ to R_{d} are the same or different and are independently of each other substituted or unsubstituted alkyl, substituted or unsubstituted alkylene, substituted or unsubstituted alkylene oxide, or halogen, or one or more non-adjacent —CH₂— in the alkyl, alkylene, and alkyleneoxide is/are replaced with —CO—; or at least two of Rₐ to R_{d} are optionally fused to form a ring.

9. The lithium rechargeable battery of claim 8, wherein Rₐ to R_{d} are alkylene oxide, one or more non-adjacent —CH₂— in the alkylene oxide is/are replaced with —CO—, and at least two of Rₐ to R_{d} are fused to form a ring.

10. The lithium rechargeable battery of claim 8, wherein the material capable of alloying with lithium includes one selected from the group consisting of Na, K, Rb, Cs, Fr, Be, Mg, Ca, Sr, Ba, Ra, Ti, Ag, Zn, Cd, Al, Ga, In, Si, Ge, Sn, Pb, Sb, Bi, and combinations thereof.

11. The lithium rechargeable battery of claim 8, wherein the material selected from the transition metal oxide, a material capable of doping and dedoping lithium comprises one selected from the group consisting of vanadium oxide, lithium vanadium oxide, Si, SiOₓ (0<x<2), Sn, SnO₂, tin alloy composites, silicon alloy composites, and combinations thereof.

12. The lithium rechargeable battery of claim 8, wherein the first lithium salt and the second lithium salt are included in a mole ratio of about 0.01:1.7 to about 1.0:0.5.

13. The lithium rechargeable battery of claim 8, wherein the first lithium salt and the second lithium salt are included in a mole ratio of about 0.1 to 1:1.

14. The lithium rechargeable battery of claim 8, wherein the first lithium salt and the second lithium salt are included in a mole ratio of about 0.4 to 1:1.

15. A lithium rechargeable battery comprising:
a negative electrode comprising a material capable of doping and dedoping lithium as a negative active material;
a non-aqueous electrolyte including a non-aqueous solvent, a first lithium salt represented by the following Chemical Formula 1, and a second lithium salt excluding boron; and
a positive electrode 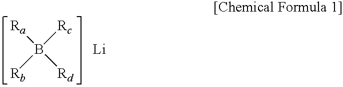
in the Chemical Formula 1,
Rₐ to R_{d} are the same or different and are independently of each other substituted or unsubstituted alkyl, substituted or unsubstituted alkylene, substituted or unsubstituted alkylene oxide, or halogen, or one or more non-adjacent —CH₂— in the alkyl, alkylene, or alkyleneoxide is/are replaced with —CO—; or at least two of Rₐ to R_{d} are optionally fused to form a ring.

16. The lithium rechargeable battery of claim 15, wherein Rₐ to R_{d} are alkylene oxide, one or more non-adjacent —CH₂— in the alkylene oxide is/are replaced with —CO—, and at least two of Rₐ to R_{d} are fused to form a ring.

17. The lithium rechargeable battery of claim 15, wherein the material capable of doping and dedoping lithium comprises Si, SiOₓ (0<x<2), Sn, SnO₂, tin alloy composites, silicon alloy composites, or combinations thereof.

18. The lithium rechargeable battery of claim 15, wherein the first lithium salt and the second lithium salt are included in a mole ratio of about 0.01:1.7 to about 1.0:0.5.

19. The lithium rechargeable battery of claim 15, wherein the first lithium salt and the second lithium salt are included in a mole ratio of about 0.1 to 1:1.

20. The lithium rechargeable battery of claim 15, wherein the first lithium salt and the second lithium salt are included in a mole ratio of about 0.4 to 1:1.
